(19) United States
(12) Patent Application Publication
(10) Pub. No.: US 2019/0340606 A1
(43) Pub. Date: Nov. 7, 2019

(54) MERCHANT QUALITY RATINGS IN A FINANCIAL COMPUTER NETWORK

(71) Applicant: Capital One Services, LLC, McLean, VA (US)

(72) Inventors: Michelle Olenoski, Washington, DC (US); Venkata Ph Kolli, Rockville, MD (US); Clayton Johnson, Edgewood, MD (US)

(73) Assignee: Capital One Services, LLC, McLean, VA (US)

(21) Appl. No.: 15/973,075

(22) Filed: May 7, 2018

(51) Int. Cl. G06Q 20/38; G06Q 20/32; G06Q 20/40; G06Q 30/02; H04L 29/08; H04W 4/021; G06Q 20/12

(52) U.S. Cl. CPC G06Q 20/382; G06Q 20/3224; G06Q 20/4016; G06Q 20/12; G06Q 30/0282; H04L 67/26; H04W 4/021; G06Q 20/383

(57) ABSTRACT

In one aspect, the present disclosure relates to a method for improving a financial computer network by providing merchant quality ratings, the method comprising: receiving, at a server device, card transaction data for a plurality of merchants; determining a first location associated with a first user device; identifying a first merchant having a location near the first location; calculating a merchant quality rating for the first merchant using the card transaction data; generating a first notification message comprising a risk assessment of the first merchant based on the merchant quality rating for the first merchant; and presenting the first notification message to a user of the first user device.

### BACKGROUND

Banks and other financial institutions may do business with a large number of merchants. While most merchants are honest and fair when dealing with customers, other merchants may be disreputable or even deceitful. For example, some merchants entice consumers to subscribe to a service by offering a “free” trial, while making it exceedingly difficult for consumers to later cancel the subscription. Banks may be unable to protect consumers from all unscrupulous merchants as there is no clear line between merchants that engage in outright fraud versus merchants that are merely disreputable.

### SUMMARY

According to one aspect, the present disclosure relates to a method for improving a financial computer network by providing merchant quality ratings, the method can include: receiving, at a server device, card transaction data for a plurality of merchants; determining a first location associated with a first user device; identifying a first merchant having a location near the first location; calculating a merchant quality rating for the first merchant using the card transaction data; generating a first notification message comprising a risk assessment of the first merchant based on the merchant quality rating for the first merchant; and presenting the first notification message to a user of the first user device.

In some embodiments, receiving card transaction data can include receiving card transaction data from a database coupled to the server device. In some embodiments, receiving card transaction data comprises receiving individual card transaction data for a plurality of merchants, and wherein calculating the merchant quality rating for the first merchant includes calculating a dispute rate and return rate for the first merchant using the individual card transaction data. In some embodiments, generating the first notification message can include generating a message indicating at least one of: the dispute rate of the first merchant compared to dispute rates for one or more other merchants; and the return rate of the first merchant compared to return rates for one or more other merchants. In some embodiments, the one or more other merchants can include merchants that conduct similar business to the first merchant.

In some embodiments, identifying the first merchant having a location near the first location can include: sending the first location to an Application Programming Interface (API) provided by a places services; receiving a response from the places service comprising place information associated with the first location; and matching the place information against a list of known merchants to identify the first merchant. In some embodiments, generating the first notification message can include generating a recommendation for using a virtual card number. In some embodiments, presenting the first notification message to the user of the first user device can include sending a push notification to the first user device.

In some embodiments, the method can include: determining a uniform resource locator (URL) associated with a website visited by a web browser of a second user device; identifying a second merchant associated with the website URL; calculating a merchant quality rating for the second merchant using the card transaction data; generating a second notification message including a risk assessment of the second merchant based on the merchant quality rating for the second merchant; and presenting the second notification message to a user of the second user device. In some embodiments, determining the website URL comprises detecting the URL by a plugin of the web browser. In some embodiments, identifying the second merchant comprises matching the website URL against a list of known merchant website URLs. In some embodiments, generating the second notification message comprises generating a recommendation for using a safe shopping mode browser extension.

According to another aspect, the present disclosure relates to a method for improving a financial computer network by providing merchant quality ratings, the method including: receiving a first location from a location sensor of a first user device; sending a first request to a server device, the first request including the first location; receiving a first notification message from the server device; and presenting the first notification message to a user of the first user device. The server device may be configured to receive card transaction data for a plurality of merchants, identify the first merchant as having a location near the first location, calculate the merchant quality rating for the first merchant using the card transaction data, and generate the first notification message comprising a risk assessment of the first merchant based on the merchant quality rating for the first merchant.

In some embodiments, the server device is configured to receiving card transaction data from a database coupled to the server device. In some embodiments, the server is configured to receive individual card transaction data for a plurality of merchants, and calculate the merchant quality rating for the first merchant includes calculating a dispute rate and return rate for the first merchant using the individual card transaction data. In some embodiments, the first notification message can include at least one of: the dispute rate of the first merchant compared to dispute rates for one or more other merchants; and the return rate of the first merchant compared to return rates for one or more other merchants. In some embodiments, the one or more other merchants can include merchants that conduct similar business to the first merchant. In some embodiments, the method can include: sending the first location to an application programming interface (API) provided by a places services; receiving a response from the places service including place information associated with the first location; and matching the place information against a list of known merchants to identify the first merchant. In some embodiments, the first notification message can include generating a recommendation for using a virtual card number.

According to another aspect, the present disclosure relates to a system for improving a financial computer network by providing merchant quality ratings, the system including a processor and a non-volatile memory. The non-volatile memory may store computer program code that when executed on the processor causes the processor to execute a process operable to: receive, at a server device, card transaction data for a plurality of merchants; determine a first location associated with a first user device; determine a first merchant having a location near the first location; calculate a merchant quality rating for the first merchant using the card transaction data; generate a first notification message including a risk assessment of the first merchant based on the merchant quality rating for the first merchant; and present the first notification message to a user of the first user device.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a diagram of an illustrative system for providing merchant quality ratings, according to some embodiments of the present disclosure.

FIGS. 2 and 3 are flow diagrams showing processing that may occur within the system of FIG. 1, according to some embodiments of the present disclosure.

FIG. 4 is a block diagram of a user device, according to some embodiments of the present disclosure.

FIG. 5 is a block diagram of a server device, according to some embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Embodiments of the present disclosure include systems and methods for presenting merchant quality ratings to consumers. A merchant quality rating may indicate how reputable a merchant is based on historical credit and/or debit card transactions associated with that merchant. In some embodiments, a merchant quality rating may be calculated using data generated by a bank during in the course of processing card transactions between the bank's customers and various merchants. A merchant quality rating may be based on, for example, a merchant's dispute rate, i.e. the percentage of transactions initiated by a merchant that are subsequently disputed by consumers. As another example, a merchant quality rating may be based on a merchant's return rate, which is the percentage of a merchant's sales that are later refunded. In some embodiments, a mobile app user can is presented with merchant quality ratings for businesses near the user's location. In some embodiments, a web browser plugin automatically presents a merchant quality rating when a user visits a website associated with a merchant.

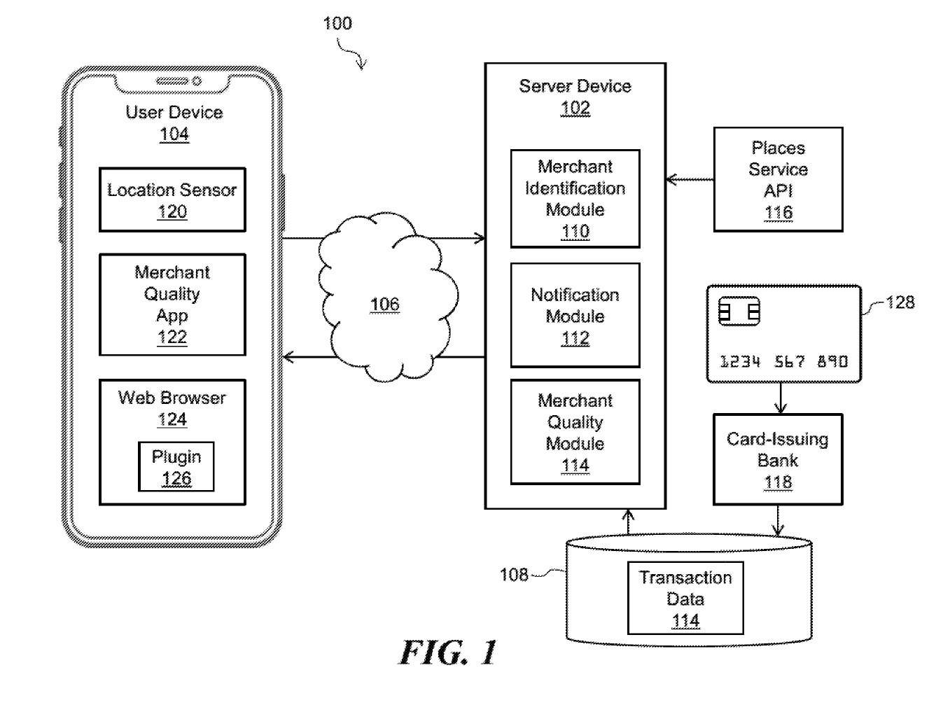

FIG. 1 shows a system 100 for providing merchant quality ratings, according to embodiments of the present disclosure. The system 100 may be part of a financial computer network that includes, for example, merchant computing devices, payment processor computing devices, and bank computing devices.

The illustrative system 100 may include one or more user devices 102 coupled to a server device 104 via a computer network 106. A user device 102 may include various hardware and software components configured to perform certain processing described herein. In some embodiments, a user device 102 is configured to execute one or more user applications (or “apps”) that can be, for example, downloaded from an app store. As illustrated in FIG. 1, a user device 102 may include a location sensor 102, an app 110, and a web browser 112. The location sensor 102 may include a Global Positioning System (GPS) receiver or other device for determining the device's geolocation. The app 110 may be a banking app, e-commerce app, or any other type of app suitable for presenting merchant quality ratings to a user. The web browser 112 may be a standalone app for browsing web pages, or may be a web browsing component integrated into an operating system of the user device 102.

The illustrative server device 104 includes a merchant identification module 116, a merchant quality rating module 118, and a user messaging module 120. Each of the server device modules 116-120 may include hardware and/or software configured to perform the corresponding processing described herein below.

The server device 104 may also include, or be operatively coupled to, a database 122. In the example of FIG. 1, database 122 may include a merchants table 123 and a transactions table 124. Merchants table 123 may store information about a plurality of merchants known to the system 100. For example, merchants table 123 may include a list of merchant names and the geolocation of stores, offices, or other real estate associated with each merchant. In some embodiments, merchants table 123 stores information about websites associated with particular merchants. For example, merchants table 123 may store the uniform resource locators (URLs) of websites that are owned by, operated by, or otherwise associated with a merchant.

Transactions table 124 may store information about card transactions associated with particular merchants. For example, when a consumer purchases goods or services from a merchant using a credit/debit card 130, the merchant may submit a sales transaction may to the card-issuing bank's computer network 128, which is then processed and stored in transactions table 124. As another example, if a user returns goods to a merchant, a refund transaction may be submitted and processed by bank computer network 128 and stored in transactions table 124. As yet another example, if a user disputes a card transaction with their bank, the bank may store information about the disputed transaction in transactions table 124. In some embodiments, a merchant's aggregate dispute rate and return rate may be calculated using individual transaction data stored in transactions table 124 for a given time period (e.g., the past 30 days, 60 days, 1 year, etc.). In some embodiments, such aggregate data may be stored in transactions table 124.

Server device 104 may have direct access to card transaction data stored by the bank computer network 128. For example, database 122 may be directly accessed by both the bank computer network 128 and the server device 104. In other embodiments, the server device 104 may obtain card transaction data using an internal/private API provided by the bank computer network 128. In either case, the system 100 may utilize proprietary bank data to provide merchant quality ratings to users.

In some embodiments, the system 100 may be configured to provide “in-store” merchant quality ratings to a user. For example, the app 110 may automatically display information about a merchant's quality rating when the user approaches a store, office, or other physical location associated with a merchant. In some embodiments, app 110 may determine the location of the device 102 using location sensor 108 and then utilize a places service 126 to determine information about a store, office, or other physical place within the vicinity of the user device 102. Places service 126 may be an external service, such as FOURSQUARE™, that provides an application programing interface (API) to lookup places in the vicinity of a given geolocation. Places service 126 may return various information about nearby places, such as the name of a business. In some embodiments, app 110 may include a software development kit (SDK) for directly issuing requests to the places service 126. In other embodiments, the app 110 may send the device's location to the server device 104 (e.g., to merchant identification module 116) which, in turn, issues requests to places service 126.

The place information returned by places service 126 may be matched against a list of known merchants to identify if there is some nearby merchant for which the system 100 can provide a merchant quality rating. In some embodiments, server device's merchant identification module 116 may compare the place information against merchant information stored within merchants table 123. In some embodiments, the user device's app 110 may compare the place information to merchant information stored within local storage 115. In some embodiments, merchant information stored in database 122 may be synchronized with merchant information stored in local storage 115.

Once a merchant is identified, the system 100 may determine a corresponding merchant quality rating using card transaction data stored for that merchant. In some embodiments, the server device 104 may determine the merchant quality rating. For example, merchant quality rating module 118 may query the transactions table 124 to determine a merchant quality rating for the identified merchant. In some embodiments, merchant quality rating module 118 may calculate a merchant quality rating dynamically using information stored in the transactions table 124. In other embodiments, merchant quality rating may be pre-computed and cached within the database 112 or other memory. In some embodiments, the app 110 may be configured to determine the merchant quality rating locally using merchant information stored in local storage 115. For example, aggregate merchant data (e.g., return rate and dispute rate) may be calculated by the server device 104 and synchronized with the user device's local storage 115.

A merchant quality rating may be provided as numeric ranking or score that indicates how reputable the merchant is relative to other merchants. In some embodiments, the merchant quality rating may include a numeric representation of the merchant's dispute and/or return rate relative to other merchants. In some embodiments, a merchant's quality rating may be calculated based on a comparison of merchants that conduct a similar type of business. For example, a retail store that sells health and beauty products may be compared to other retailers that sell health and beauty products, or to other retail stores in general.

The system 100 may generate a notification message comprising a risk assessment of the merchant based on the merchant quality rating. For example, a notification message may state “MERCHANT X has a dispute rate 2 times higher than other health and beauty supply stores” or “MERCHANT Y has a return rate 5 times higher than normal.” The notification message may be presented to the user of the user device 102. In some embodiments, the message may be displayed within the app 110. In some embodiments, the server device's user messaging module 120 may cause a push notification to be sent to user device 102, the push notification including the generated notification message for the merchant.

The system 100 may also be configured to provide a merchant quality rating to a user when the user visits a website associated with a known merchant. In some embodiments, a browser plugin 114 may be installed on the user device 102 and configured to detect when a website URL is visited by the web browser 112. The system 100 may compare the URL to a list of known merchant website URLs associated with the visited website. In some embodiments, the server device 104 may identify a merchant based on the URL. For example, the browser plugin 114 may send the visited website URL to merchant identification module 116 which in turn may query the merchants table 123 to identify a merchant associated with that URL. In other embodiments, the user device 102 may identify the merchant locally, for example using merchant information stored/cached within local storage 115. Once a merchant is identified, the system 100 may determine a merchant quality rating and present a corresponding notification message to the user, as described above.

In some embodiments, the system 100 may perform one or more remedial actions to reduce the risk that a “low quality” merchant may pose to the user. A “low quality” merchant may be defined as a merchant having a numeric merchant quality rating that is below some predetermined threshold value. In some embodiments, the system 100 may recommend that the user uses a virtual credit/debit card number (in contrast to an actual card number) when transacting with the merchant. In some embodiments, the system 100 may recommend that the user install/activate a web browser extension that provides a “safe shopping” mode. A safe shopping browser extension can cause the web browser to not store any personally identifiable during the shopping session.

It will be appreciated that the system 100 may be provided as part of, or closely coupled to, a bank computer network 128. The system 100 may rely on transaction data and other data that is uniquely available to banks in order to provide accurate merchant quality ratings to users, including bank customers and non-customers.

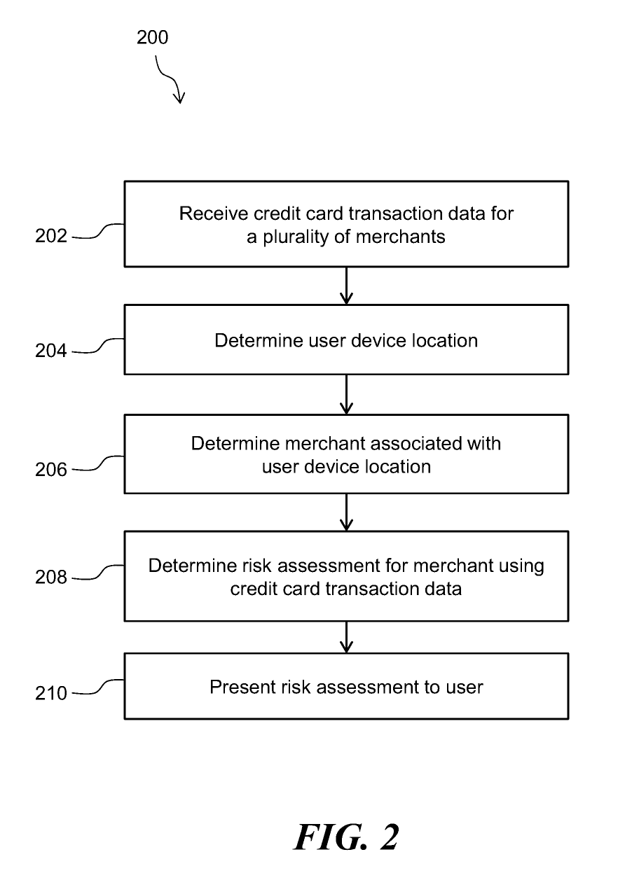

Referring to FIG. 2, a method 200 may be used to provide “in-store” merchant quality ratings. Portions of the method 200 may be performed by a server device (e.g., server device 104 in FIG. 1) and/or by a user device (e.g., user device 102 in FIG. 1).

At block 202, card transaction data may be received for a plurality of merchants. The card transaction data may include individual credit/debit card transactions or aggregate transaction data such as merchant dispute rate and return rate. In some embodiments, the card transaction data may be stored in a database coupled to the server device (e.g., within database 122 in FIG. 1).

At block 204, the location of the user device may be determined, for example using a GPS receiver or other location sensor within the user device. At block 206, a merchant is identified having a location near the user device's location. In some embodiments, a places service (e.g., places service 126 in FIG. 1) may be used to retrieve information about nearby stores, offices, or other physical places in the vicinity of the user device location. The place information may be matched against a list of known merchants (e.g., merchants table 123 of FIG. 1) to identify a merchant near the user device.

At block 208, a merchant quality rating may be determined for the merchant based on the card transaction data. In some embodiments, the merchant quality rating may indicate whether the merchant has a relatively dispute rate or return rate higher compared to other merchants. At block 210, a notification message may be generated, the notification message comprising a risk assessment of the merchant based on the merchant quality rating.

At block 212, the notification message may be presented to a user of the user device. In some embodiments, the notification message may be displayed within an app running on the user device. In other embodiments, the notification message may be sent as a push notification to the user device.

In some embodiments, the method 200 may include perform one or more remedial actions to reduce the risk that a “low quality” merchant may pose to the user. For example, a notification may be displayed suggesting that the user use a virtual credit/debit card number (in contrast to an actual card number) when transacting with the nearby merchant.

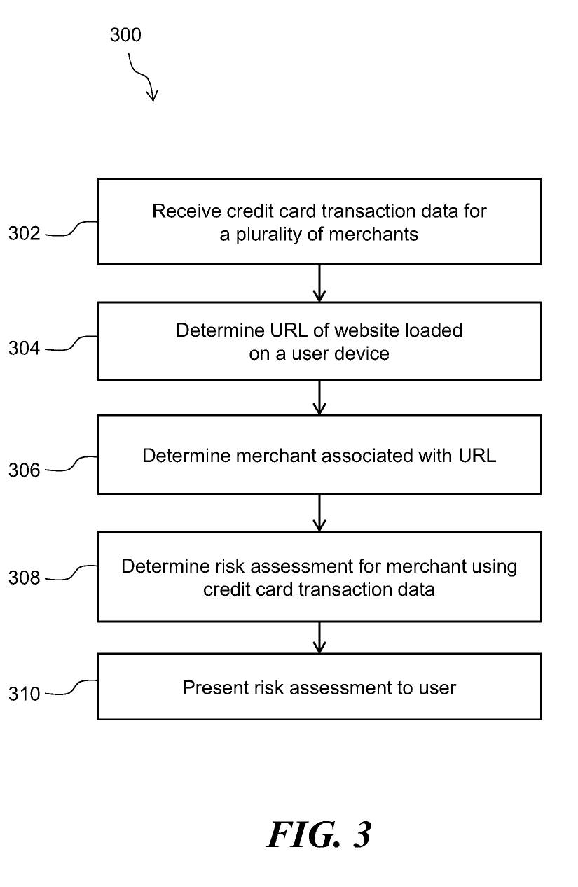

Referring to FIG. 3, a method 300 may be used to present a merchant quality rating when a user visits a website associated a merchant. Portions of the method 300 may be performed by a server device (e.g., server device 104 in FIG. 1) and/or by a user device (e.g., user device 102 in FIG. 1).

At block 302, card transaction data may be received for a plurality of merchants. The card transaction data may include individual credit/debit card transactions or aggregate transaction data such as merchant dispute rate and return rate. In some embodiments, the card transaction data may be stored in a database coupled to the server device (e.g., within database 122 in FIG. 1).

At block 304, in response to a user visiting a website within a web browser of the device, the website's URL may be determined (e.g., by a browser plugin installed on the user device). At block 306, a merchant associated with the website URL may be identified, for example by matching the URL a list of known merchant website URLs (e.g., URLs stored within merchants table 123 of FIG. 1).

At block 308, a merchant quality rating may be determined for the merchant based on the card transaction data. In some embodiments, the merchant quality rating may indicate whether the merchant has a relatively dispute rate or return rate higher compared to other merchants. At block 310, a notification message may be generated, the notification message comprising a risk assessment of the merchant based on the merchant quality rating.

At block 312, the notification message may be presented to a user of the user device. In some embodiments, the notification message may be displayed within the web browser running on the user device.

In some embodiments, the method 300 may include perform one or more remedial actions to reduce the risk that a “low quality” merchant may pose to the user. For example, a recommendation may be made to the user to install/activate a web browser extension that provides a “safe shopping” mode.

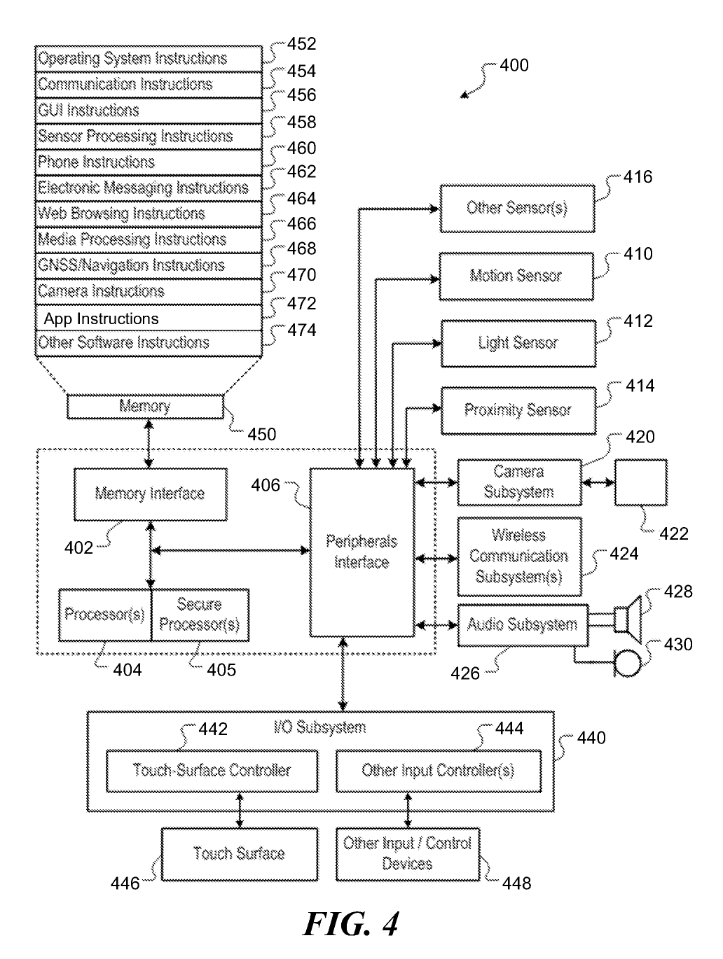

FIG. 4 shows a user device 400, according to an embodiment of the present disclosure. The illustrative user device 400 may include a memory interface 402, one or more data processors, image processors, central processing units 404, and/or secure processing units 405, and a peripherals interface 406. The memory interface 402, the one or more processors 404 and/or secure processors 405, and/or the peripherals interface 406 may be separate components or may be integrated in one or more integrated circuits. The various components in the user device 400 may be coupled by one or more communication buses or signal lines.

Sensors, devices, and subsystems may be coupled to the peripherals interface 406 to facilitate multiple functionalities. For example, a motion sensor 410, a light sensor 412, and a proximity sensor 414 may be coupled to the peripherals interface 406 to facilitate orientation, lighting, and proximity functions. Other sensors 416 may also be connected to the peripherals interface 406, such as a global navigation satellite system (GNSS) (e.g., GPS receiver), a temperature sensor, a biometric sensor, magnetometer, or other sensing device, to facilitate related functionalities.

A camera subsystem 420 and an optical sensor 422, e.g., a charged coupled device (CCD) or a complementary metal-oxide semiconductor (CMOS) optical sensor, may be utilized to facilitate camera functions, such as recording photographs and video clips. The camera subsystem 420 and the optical sensor 422 may be used to collect images of a user to be used during authentication of a user, e.g., by performing facial recognition analysis.

Communication functions may be facilitated through one or more wired and/or wireless communication subsystems 424, which can include radio frequency receivers and transmitters and/or optical (e.g., infrared) receivers and transmitters. For example, the Bluetooth (e.g., Bluteooth low energy (BTLE)) and/or WiFi communications described herein may be handled by wireless communication subsystems 424. The specific design and implementation of the communication subsystems 424 may depend on the communication network(s) over which the user device 400 is intended to operate. For example, the user device 400 may include communication subsystems 424 designed to operate over a GSM network, a GPRS network, an EDGE network, a WiFi or WiMax network, and a Bluetooth™ network. For example, the wireless communication subsystems 424 may include hosting protocols such that the device 400 can be configured as a base station for other wireless devices and/or to provide a WiFi service.

An audio subsystem 426 may be coupled to a speaker 428 and a microphone 430 to facilitate voice-enabled functions, such as speaker recognition, voice replication, digital recording, and telephony functions. The audio subsystem 426 may be configured to facilitate processing voice commands, voiceprinting, and voice authentication, for example.

The I/O subsystem 440 may include a touch-surface controller 442 and/or other input controller(s) 444. The touch-surface controller 442 may be coupled to a touch surface 446. The touch surface 446 and touch-surface controller 442 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 446.

The other input controller(s) 444 may be coupled to other input/control devices 448, such as one or more buttons, rocker switches, thumb-wheel, infrared port, USB port, and/or a pointer device such as a stylus. The one or more buttons (not shown) may include an up/down button for volume control of the speaker 428 and/or the microphone 430.

In some implementations, a pressing of the button for a first duration may disengage a lock of the touch surface 446; and a pressing of the button for a second duration that is longer than the first duration may turn power to the user device 400 on or off. Pressing the button for a third duration may activate a voice control, or voice command, module that enables the user to speak commands into the microphone 430 to cause the device to execute the spoken command. The user may customize a functionality of one or more of the buttons. The touch surface 446 can, for example, also be used to implement virtual or soft buttons and/or a keyboard.

In some implementations, the user device 400 may present recorded audio and/or video files, such as MP3, AAC, and MPEG files. In some implementations, the user device 400 may include the functionality of an MP3 player, such as an iPod™. The user device 400 may, therefore, include a 36-pin connector and/or 8-pin connector that is compatible with the iPod. Other input/output and control devices may also be used.

The memory interface 402 may be coupled to memory 450. The memory 450 may include high-speed random access memory and/or non-volatile memory, such as one or more magnetic disk storage devices, one or more optical storage devices, and/or flash memory (e.g., NAND, NOR). The memory 450 may store an operating system 452, such as Darwin, RTXC, LINUX, UNIX, OS X, WINDOWS, or an embedded operating system such as VxWorks.

The operating system 452 may include instructions for handling basic system services and for performing hardware dependent tasks. In some implementations, the operating system 452 may be a kernel (e.g., UNIX kernel). In some implementations, the operating system 452 may include instructions for performing voice authentication.

The memory 450 may also store communication instructions 454 to facilitate communicating with one or more additional devices, one or more computers and/or one or more servers. The memory 450 may include graphical user interface instructions 456 to facilitate graphic user interface processing; sensor processing instructions 458 to facilitate sensor-related processing and functions; phone instructions 460 to facilitate phone-related processes and functions; electronic messaging instructions 462 to facilitate electronic-messaging related processes and functions; web browsing instructions 464 to facilitate web browsing-related processes and functions; media processing instructions 466 to facilitate media processing-related processes and functions; GNSS/Navigation instructions 468 to facilitate GNSS and navigation-related processes and instructions; and/or camera instructions 470 to facilitate camera-related processes and functions.

The memory 450 may store instructions 472 for one or more applications installed on the user device that determine and/or present merchant quality ratings to the user. For example, instructions 472 may include instructions corresponding to the app 110 and/or the browser plugin 114 described above in the context of FIG. 1. The memory 450 may store other software instructions 474 configured to perform processing described herein.

Each of the above identified instructions and applications may correspond to a set of instructions for performing one or more functions described herein. These instructions need not be implemented as separate software programs, procedures, or modules. The memory 450 may include additional instructions or fewer instructions. Furthermore, various functions of the user device 400 may be implemented in hardware and/or in software, including in one or more signal processing and/or application specific integrated circuits.

In some embodiments, processor 404 may perform processing including executing instructions stored in memory 450, and secure processor 405 may perform some processing in a secure environment that may be inaccessible to other components of user device 400. For example, secure processor 405 may include cryptographic algorithms on board, hardware encryption, and physical tamper proofing. Secure processor 405 may be manufactured in secure facilities. Secure processor 405 may encrypt data/challenges from external devices. Secure processor 405 may encrypt entire data packages that may be sent from user device 400 to the network. Secure processor 405 may separate a valid user/external device from a spoofed one, since a hacked or spoofed device may not have the private keys necessary to encrypt/decrypt, hash, or digitally sign data, as described herein.

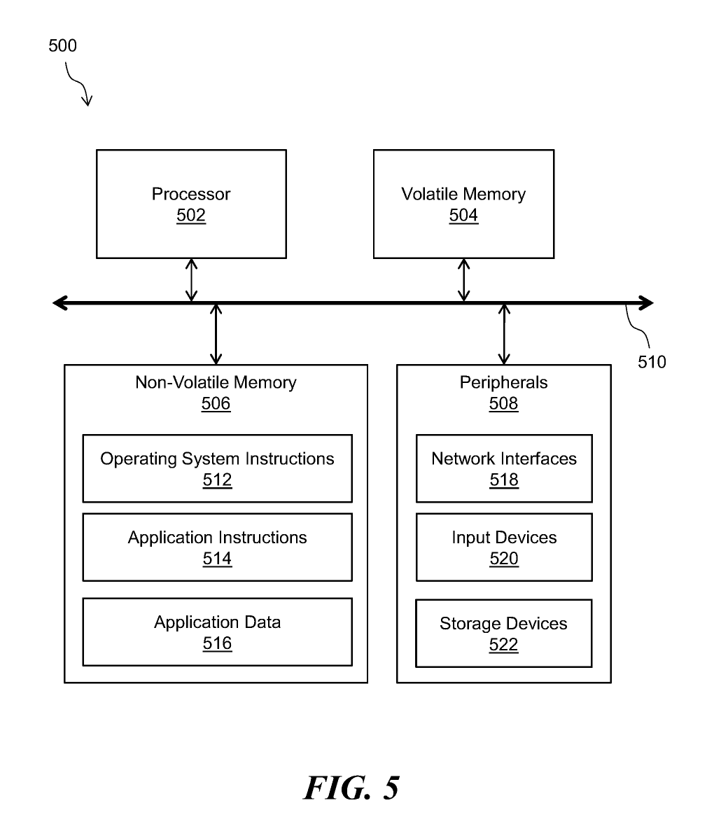

FIG. 5 shows an illustrative server device 500 that may implement various features and processes as described herein. The server device 500 may be implemented on any electronic device that runs software applications derived from compiled instructions, including without limitation personal computers, servers, smart phones, media players, electronic tablets, game consoles, email devices, etc. In some implementations, the server device 500 may include one or more processors 502, volatile memory 504, non-volatile memory 506, and one or more peripherals 508. These components may be interconnected by one or more computer buses 510.

Processor(s) 502 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 510 may be any known internal or external bus technology, including but not limited to ISA, EISA, PCI, PCI Express, NuBus, USB, Serial ATA or FireWire. Volatile memory 504 may include, for example, SDRAM. Processor 502 may receive instructions and data from a read-only memory or a random access memory or both. The essential elements of a computer may include a processor for executing instructions and one or more memories for storing instructions and data.

Non-volatile memory 506 may include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 506 may store various computer instructions including operating system instructions 512 and application instructions 514. Operating system instructions 512 may include instructions for implementing an operating system (e.g., Mac OS®, Windows®, or Linux). The operating system may be multi-user, multiprocessing, multitasking, multithreading, real-time, and the like. The operating system instructions 512 may include network communications instructions, for example, software for implementing communication protocols, such as TCP/IP, HTTP, Ethernet, telephony, etc. Application instructions 514 can include instructions for determining and/or presenting merchant quality ratings. For example, application instructions 514 may include instructions for modules 116-120 described above in conjunction with FIG. 1. Application data 516 may correspond to data stored by the applications running on the server device 500. For example, Application data may 516 may include stored merchant information and/or stored card transaction data.

Peripherals 508 may be included within the server device 500 or operatively coupled to communicate with the sever device 500. Peripherals 508 may include, for example, network interfaces 518, input devices 520, and storage devices 522. Network interfaces may include for example an Ethernet or WiFi adapter. Input devices 520 may be any known input device technology, including but not limited to a keyboard (including a virtual keyboard), mouse, track ball, and touch-sensitive pad or display. Storage devices 522 may include one or more mass storage devices for storing data files; such devices include magnetic disks, such as internal hard disks and removable disks; magneto-optical disks; and optical disks.

Methods described herein may represent processing that occurs within a system for providing merchant quality ratings (e.g., system 100 of FIG. 1). The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, such as EPROM, EEPROM, flash memory device, or magnetic disks. The processor and the memory can be supplemented by, or incorporated in, special purpose logic circuitry.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method for improving a financial computer network by providing merchant quality ratings, the method comprising:
receiving, at a server device, card transaction data for a plurality of merchants, wherein receiving card transaction data comprises receiving data for individual card transactions from a card-issuing entity using a private Application Programming Interface (API);
determining a first location associated with a first user device, the first user device operated by a first user associated with the card-issuing entity;
sending the first location from the server device to an API provided by a places service;
receiving a response from the places service comprising place information associated with the first location;
matching the place information against a list of known merchants to identify a first merchant;
calculating a merchant quality rating for the first merchant using the card transaction data;
generating a first notification message comprising a risk assessment of the first merchant based on the merchant quality rating for the first merchant;
presenting the first notification message to the first user;
determining a second location associated with a second user device, the second user device operated by second user not associated with the card-issuing entity;
identifying a second merchant associated with the second location;
calculating a merchant quality rating for the second merchant using the card transaction data;
generating a second notification message comprising a risk assessment of the second merchant based on the merchant quality rating for the second merchant and
presenting the second notification message to the second user.

2. The method of claim 1 wherein receiving card transaction data comprises receiving card transaction data from a database coupled to the server device.

3. The method of claim 1 wherein receiving card transaction data comprises receiving individual card transaction data for a plurality of merchants, and wherein calculating the merchant quality rating for the first merchant comprises calculating a dispute rate and return rate for the first merchant using the individual card transaction data.

4. The method of claim 3 wherein generating the first notification message comprises generating a message indicating at least one of:
the dispute rate of the first merchant compared to dispute rates for one or more other merchants; and
the return rate of the first merchant compared to return rates for one or more other merchants.

5. The method of claim 4 wherein the one or more other merchants comprise merchants that conduct similar business to the first merchant.

6. (canceled)

7. The method of claim 1 wherein generating the first notification message comprises generating a recommendation for using a virtual card number.

8. The method of claim 1 wherein presenting the first notification message to the user of the first user device comprises sending a push notification to the first user device.

9. The method of claim 1 comprising:
determining a uniform resource locator (URL) associated with a website visited by a web browser of a third user device;
identifying a third merchant associated with the website URL;
calculating a merchant quality rating for the third merchant using the card transaction data;
generating a third notification message comprising a risk assessment of the third merchant based on the merchant quality rating for the third merchant; and
presenting the third notification message to a user of the third user device.

10. The method of claim 9 wherein determining the website uniform resource locator (URL) comprises detecting the URL by a plugin of the web browser.

11. The method of claim 9 wherein identifying the third merchant comprises matching the website URL against a list of known merchant website URLs.

12. The method of claim 9 wherein generating the third notification message comprises generating a recommendation for using a safe shopping mode browser extension, wherein the safe shopping browser extension blocks the web browser from storing any personally identifiable information during the shopping session.

13. A method for improving a financial computer network by providing merchant quality ratings, the method comprising:
receiving a first location from a location sensor of a first user device;
sending a first request to a server device, the first request comprising the first location, wherein the server device is configured to:
receive card transaction data for a plurality of merchants,
send the first location from the server device to an Application Programming Interface (API) provided by a places services service,
receive a response from the places service comprising place information associated with the first location,
match the place information against a list of known merchants to identify a first merchant,
calculate the merchant quality rating for the first merchant using the card transaction data, and
generate a first notification message comprising a risk assessment of the first merchant based on the merchant quality rating for the first merchant;
receiving the first notification message from the server device; and
presenting the first notification message to a user of the first user device.

14. The method of claim 13 wherein the server device is configured to receiving card transaction data from a database coupled to the server device.

15. The method of claim 13 wherein the server is configured to:
receive individual card transaction data for a plurality of merchants; and
calculate the merchant quality rating for the first merchant comprises calculating a dispute rate and return rate for the first merchant using the individual card transaction data.

16. The method of claim 15 wherein the first notification message comprises at least one of:
the dispute rate of the first merchant compared to dispute rates for one or more other merchants; and
the return rate of the first merchant compared to return rates for one or more other merchants.

17. The method of claim 16 wherein the one or more other merchants comprise merchants that conduct similar business to the first merchant.

18. (canceled)

19. The method of claim 13 wherein the first notification message comprises generating a recommendation for using a virtual card number.

20. A system for improving a financial computer network by providing merchant quality ratings, the system comprising:
a processor; and
a non-volatile memory storing computer program code that when executed on the processor causes the processor to execute a process operable to:
receive, at a server device, card transaction data for a plurality of merchants;
determine a first location associated with a first user device, the first user device operated by a first user;
send the first location from the server device to an Application Programming Interface (API) provided by a places service;
receive a response from the places service comprising place information associated with the first location;
match the place information against a list of known merchants to identify a first merchant associated with the first location;
calculate a merchant quality rating for the first merchant using the card transaction data;
generate a first notification message comprising a risk assessment of the first merchant based on the merchant quality rating for the first merchant;
present the first notification message to the first user at the first location;
determine a second location associated with a second user device, the second user device operated by a second user;
identify a second merchant associated with the second location;
calculate a merchant quality rating for the second merchant using the card transaction data;
generate a second notification message comprising a risk assessment of the second merchant based on the merchant quality rating for the second merchant and
present the second notification message to the second user at the second location.
